(19) United States
(12) Patent Application Publication
(10) Pub. No.: US 2005/0188799 A1
(43) Pub. Date: Sep. 1, 2005

(54) Layout design tool and method of using

(76) Inventor: Sherry Kocienski, Schenectady, NY (US)

Correspondence Address: National IP Rights Center, LLC;Suite 400, 550 Township Line Road, Blue Bell, PA, 19422, US

(21) Appl. No.: 10/787,844

(22) Filed: Feb. 26, 2004

(51) Int. Cl. B26D 1/00

(52) U.S. Cl. 83/13

(57) ABSTRACT

A layout design tool and method of using is disclosed. The layout design tool includes a substantially flat base portion formed of a magnetic material, and a plurality of shaped portions, formed of a magnetic material, wherein the plurality of shaped portions are detachably attached to the substantially flat base portion by magnetism. The method of using a layout design tool for laying out a design includes the steps of attaching one of a plurality of shaped portions to a substantially flat base portion, and moving the one of plurality of shaped portions as needed on the substantially flat base portion.

### FIELD OF THE INVENTION

The present invention relates to a tool and method for laying out a design on paper, and in particular to a tool and method for laying out a design for scrapbooks, and the like.

### BACKGROUND OF THE INVENTION

When involved in any sort of design application, it is important to be able to visualize what the finished product will look like. That way, before a designer goes through all the effort of making the design, he or she will have some idea what the end product will be. Currently, a designer can only imagine what the finished product will look like unless he or she sketches the design out on paper. However, this limits the designer in that he or she has to completely redraw the entire page in order to make changes. Otherwise, the designer may be faced with a final design that he or she did not anticipate and in which he or she will not be pleased.

U.S. Pat. No. 6,418,635 is directed to a template for guiding an implement on a design page, such as a scrapbook page. The template has a first plurality of interior edges defining shapes and a second plurality of interior edges defining borders around the shapes. The first and second pluralities of interior edges are configured on the template so as to provide a layout that is transferrable to the design page. According to one embodiment, the interior edges are configured on the template so as to provide a layout which is transferrable to the design page without having to reposition the template. The layout is employed, according to one embodiment, to arrange display objects, such as photographic or hand-drawn pictures, on the design page. In one embodiment, the template has a third plurality of interior edges defining slots, which are employed to guide a user in writing captions corresponding to the displayed objects.

U.S. Pat. No. 6,321,457 discloses a cutting template for use in cutting a geometric shape or pattern, such as an oval, of any size, into or out of a selected medium. A preferred embodiment configured according to the invention includes a transparent or translucent sheet with two or more grooves therein that generally define a selected geometric pattern, and additional grooves in the sheet define one or more similar patterns that differ in size, with the several different size patterns being arranged in a nested relationship. The grooves serve as guide channels for a cutting instrument that extends directly through the channels into cutting relation with an underlying medium, thereby eliminating any need for separately tracing the desired pattern onto the medium. Different embodiments of the invention have sets of grooves which define different shapes.

U.S. Pat. No. 6,575,068 is directed to a guided cutting system including first and second blade cartridges which are used in association with templates. The blade cartridges each include a head and cover portions wherein the head portion includes a non-use end and a cutting end. The cutting end includes a pair of guide pegs and a cutting blade wherein the guide pegs are adapted to be received within a peripheral groove formed on a template. The cover portion is adapted to be attached to the non-use end of the head portion whereby the cover portion acts as a handle. The head portion may be attached over the cutting end to cover and prevent contact with the cutting blade. A different spacing is provided between the cutting blade and guide pegs for the first and second head portions for cropping a photograph and cutting a corresponding backing mat for the photograph.

U.S. Pat. No. 5,865,928 discloses a novel method of manufacturing collage puzzle pieces comprising the steps of: (a) providing a template in sheet form having a plurality of channels in the form of line perforations so as to define a plurality of puzzle pieces patterns, the channels being interrupted at selected locations so that at least one portion of each puzzle piece pattern is connected to at least one adjacent puzzle piece pattern; (b) mounting at least one selected graphic art object on an adhesive-coated substrate so as to form a workpiece; (c) assembling the workpiece and the template so that the template overlies the at least one graphic art object; (d) drawing a cutting blade along the full length of each channel defining a selected puzzle piece pattern so as to cut the underlying workpiece along lines conforming to the shape and location of the selected puzzle piece pattern, whereby to form a connected puzzle piece in the workpiece; (e) separating the template from the workpiece; (f) severing the connected puzzle piece from the workpiece; and (g) repeating steps (a) to (f) using the same template but workpieces that comprise different graphic arts objects, with each repetition of step (d) involving a different selected puzzle piece pattern, whereby a plurality of different puzzle pieces are formed. These puzzle pieces are combined to form a collage puzzle.

U.S. Pat. No. 6,112,425 is directed to a template for guiding a writing or cutting implement which comprises a plurality of patterns along its outer edges. In one embodiment, the template has four outer edges, each comprising a different pattern. The template further comprises a plurality of voids or cut-outs defined by shape-defining edges, disposed within the face of the template. The template further comprises a plurality of corner hole edges, center hole edges and rectangular marker hole edges for facilitating the positioning of the template on to a transfer sheet. Another embodiment of the template includes a layering system, designed to enable stenciling of a unique layered pattern. The layering system comprises a plurality of sets of voids or cut-outs defined by shape-defining edges, each set having a plurality of marker holes associated therewith. Each set of shapes is stenciled after being successively aligned with a marked drawing spot, and a layered effect is created by stenciling only that portion of each shape from a set which does not overlap any shapes from a previously stenciled set.

There is a need, however, for a tool and method that will allow a designer of scrapbooks or the like, to be able to lay out the design first before having to commit it to something permanent. The tool and method would have to provide the designer with a way to lay the design out and manipulate it at his or her leisure.

### OBJECTS AND SUMMARY OF THE INVENTION

It is therefore an object of the present invention to provide a novel tool for preparing layouts for scrapbooks that allows a designer to layout a design for a scrapbook before finalizing the design.

It is another object of the present invention to provide a novel tool for preparing layouts for scrapbooks that allows a designer to attach a plurality of shapes to a flat portion, simulating a page, to evaluate a design for a scrapbook, where the plurality of shapes and flat portion are magnetized.

It is yet another object of the present invention to provide a method of laying out a design for a scrapbook where the designer can attach a plurality of shapes to a flat portion, and then move them around as needed for a design.

In accordance with a first aspect of the present invention, a novel tool for preparing layouts for scrapbooks that allows the designer to layout a design before finalizing it. The tool includes a substantially flat base portion, and a plurality of shaped portions, detachably mounted on the substantially flat base portion.

In accordance with another aspect of the present invention, a novel tool for preparing layouts for scrapbooks that allows the designer to layout a design before finalizing it having a magnetized plurality of shaped portions and a magnetized flat portion.

In accordance with yet another aspect of the present invention, a novel method of laying out a design for a scrapbook using a design tool is provided. The method includes attaching one of a plurality of shaped portions to a substantially flat base portion, and moving the one of plurality of shaped portions as needed on the substantially flat base portion.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a perspective view of a layout design tool in accordance with the present invention.

FIGS. 2A-2E are representative shaped portions of the layout design tool in accordance with the present invention.

FIG. 3 is a flow diagram of a method of laying out a design for a scrapbook in accordance with the present invention.

### DETAILED DESCRIPTION OF THE PREFERRED EMBODIMENTS

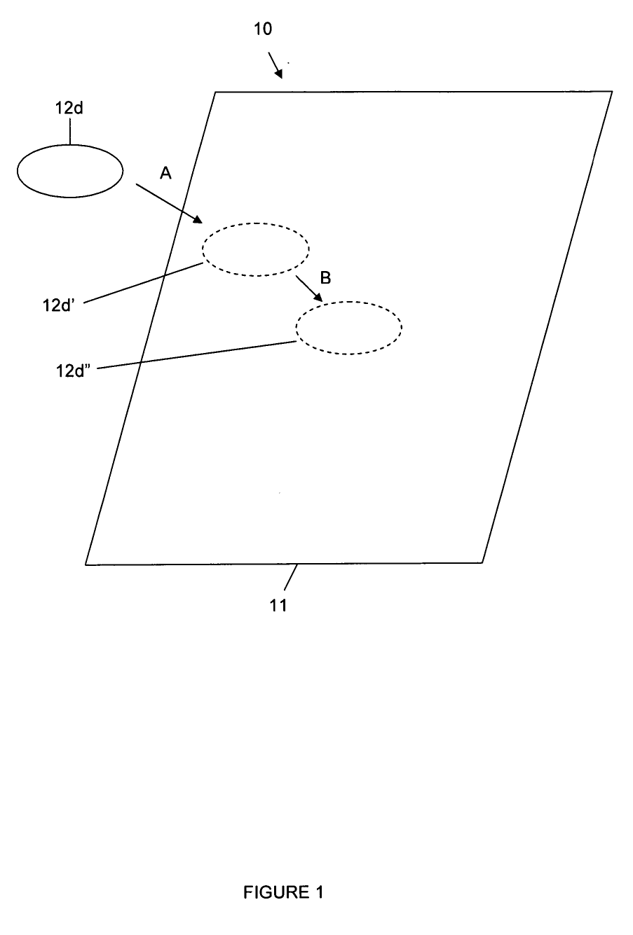

Referring now to the drawings wherein like reference numerals refer to the same component across the several views, and in particular to FIG. 1, there is shown a layout design tool 10. The layout design tool 10 includes a substantially flat base portion 11 and a plurality of shaped portions 12.

The plurality of shaped portions 12 are able to be detachably mounted to the substantially flat portion 11. In a preferred embodiment of the present invention, the plurality of shaped portions 12 and the substantially flat base portion 11 are magnetized so as to allow the plurality of shaped portions 12 to be easily be attached, detached, and manipulated once attached to the substantially flat base portion 11. However, any means known to one of ordinary skill in the art may be employed to detachably attach the plurality of shaped portions 12 to the substantially flat portion 11. Additionally, in a preferred embodiment of the present invention, the material used to form the substantially flat portion 11 and the plurality of shaped portions 12, will be formed of a material that a designer can write on and erase for reusability.

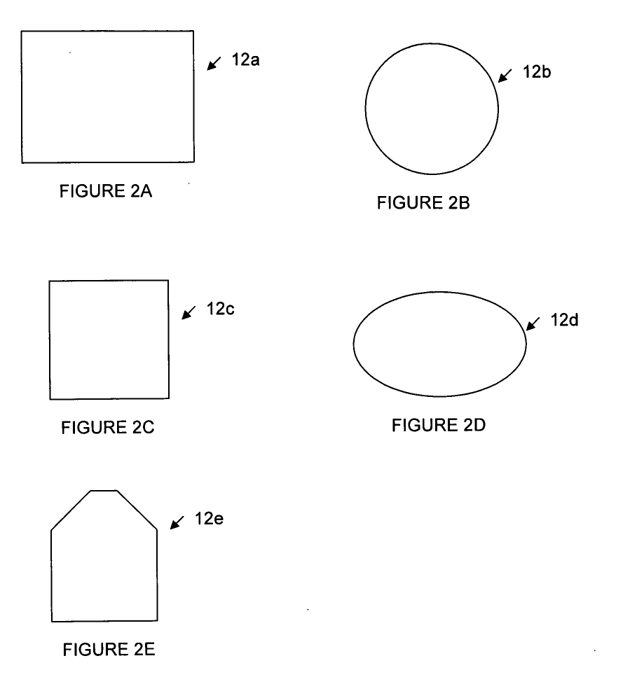

Referring now to FIGS. 2A-2E, some representative shapes of the plurality of shaped portions 12 are shown. For example, shaped portion 12a is a substantially rectangular shape and could be used for various purposes such as journaling, metal accents, borders, and layering backgrounds, among other uses. The shaped portions 12b and 12d depict circles and ovals, respectively, which, among other things, can be used for circle or oval tags, mini letter mattes, embellishments, borders, or metal accents. The shaped portion 12c is substantially square and can be used, for instance, for journaling, square tags, titles, embellishments, and borders. The shaped portion 12e is a somewhat truncated rectangle, and can be used as a tag to hold journaling, titles, embellishments, and letters, to name a few. The size of all the shaped portions 12 can vary as needed to one of ordinary skill in the art.

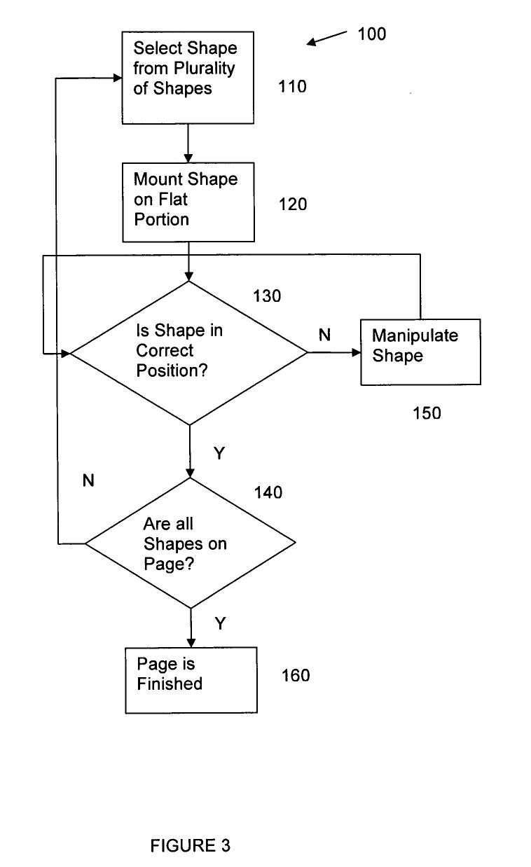

Referring now to FIG. 1 and, more particularly to FIG. 3, a representative flow diagram for a method of laying out a design for a scrapbook 100 is shown. The designer selects a shape from one of the plurality of shaped portions 12 in step 110. For example, the designer may utilize an oval shaped portion 12d as illustrated in FIG. 1, however, any one of the plurality of shaped portions 12 may be used. In step 120, the designer attaches, or mounts, the oval shaped portion 12d to the substantially flat portion 11 along the arrow ‘A’ where he or she wants to see how it looks, and depicted by oval shaped portion 12d′ in FIG. 1. If the designer is pleased with the position of the oval shaped portion 12d′ in step 130, then he or she proceeds on to step 140. If the designer is not pleased with the position of the oval shaped portion 12d′ on the substantially flat portion 11, then the designer can manipulate the oval shaped portion 12d′ by translating, lifting it and replacing it, or rotating it as the designer sees fit in step 150. For example, a translation of the oval shaped portion 12d′ is depicted in FIG. 1 along the line ‘B’, becoming the oval shaped portion 12d″. Once the oval shaped portion 12d′ in step 130, or the oval shaped portion 12d″ in step 150 is in the proper place, then the designer has to decide if all the shaped portions 12 are positioned on the substantially flat portion 11 where he or she desires in step 140. If so, then the designer proceeds to step 160 and the page is finished. Otherwise, the designer proceeds back to step 110 and begins the process over with the selection of another shaped portion 12 to be placed on the substantially flat portion 11.

In view of the foregoing disclosure, some advantages of the present invention can be seen. For example, a novel layout design tool and method of using is disclosed. The tool includes a flat portion to simulate a page, and shaped portions that can be detachably attached to the flat portion to simulate various design components on the page. The flat portion and shaped portions can be written on, and erased as needed, and the shaped portions can be moved around on the flat portion so that a designer can see what the page will look like laid out prior to finalizing his or her design, thereby increasing efficiency and decreasing cost to the consumer.

While the,preferred embodiment of the present invention has been described and illustrated, modifications may be made by one of ordinary skill in the art without departing from the scope and spirit of the invention as defined in the appended claims. For example, in a preferred embodiment of the present invention, both the substantially flat portion and the plurality of shaped portions are magnetically attracted to each other to facilitate attaching and reattaching them to one another. However, other means of detachably attaching the shaped portions to the substantially flat portion known to one of ordinary skill in the art may be employed. For example, a hook and loop system, such as VELCRO®, may be used by having the “hooks” on one face of either the substantially flat portion or the plurality of shaped portions, and the “loops” on the face of the other of the substantially flat portion or the plurality of shaped portions. Additionally, the substantially flat portion and the plurality of shaped portions may be statically attracted to one another, in addition to any other detachable attachment means known to one of ordinary skill in the art.

1. A layout design tool, comprising:
a substantially flat base portion; and
a plurality of shaped portions, detachably attached on the substantially flat base portion.

2. The tool of claim 1, wherein the substantially flat base portion and the plurality of shaped portion are formed of a magnetic material.

3. The tool of claim 1, wherein the plurality of shaped portions are detachably attached to the substantially flat portion by static attraction.

4. The tool of claim 1, wherein the plurality of shaped portions are detachably attached to the substantially flat portion by a hook and loop fastener system.

5. The tool of claim 1, wherein the substantially flat base portion and the plurality of shaped portions are formed of a material that can be written on and erased.

6. A layout design tool, comprising:
a substantially flat base portion formed of a magnetic material; and
a plurality of shaped portions, formed of a magnetic material, wherein the plurality of shaped portions are detachably attached to the substantially flat base portion by magnetism.

7. A method of laying out a design using a substantially flat base portion and a plurality of shaped portions detachably attached to the substantially flat portion, comprising the steps of:
attaching one of the plurality of shaped portions to the substantially flat base portion; and
moving the one of plurality of shaped portions as needed on the substantially flat base portion.

8. The method of claim 4, further comprising the step of attaching additional shaped portions to the substantially flat base portion and moving the additional shaped portions as need on the substantially flat base portion.
